(19) United States
(12) Patent Application Publication
(10) Pub. No.: US 2017/0256185 A1
(43) Pub. Date: Sep. 7, 2017

(54) SEAT ACCESSORY

(71) Applicant: Reginald John Illingworth, Bristol (GB)

(72) Inventors: Reginald John Illingworth, Bristol (GB); Lorna Elizabeth Page, Bristol (GB)

(21) Appl. No.: 15/517,452

(22) PCT Filed: Oct. 8, 2015
(86) PCT No.: PCT/GB2015/052947

§ 371 Date: Apr. 6, 2017

Related U.S. Application Data
(60) Provisional application No. 62/159,692, filed on May 11, 2015.
(60) Provisional application No. 62/061,719, filed on Oct. 9, 2014.

(51) Int. Cl. G09F 21/02; G09F 27/00; G09F 13/22

(52) U.S. Cl. CPC G09F 21/02; G09F 13/22; G09F 27/005; G09F 2021/023; G09F 2023/005

(57) ABSTRACT

A seat accessory (10) comprises an elongate, generally planar member which is deformable in order to secure the ends to the opposite edges of a seat back. The elongate, generally planar member comprises two generally planar deformable elongate portions (16a, 16b) which are separably joined to one other. At least one of the portions (16a, 16b), when separated, comprises a wearable item which is deformable to wrap around a body portion of a wearer.

The present invention relates to a seat accessory and in particular, but not exclusively, to a stadium-type seat accessory which can also be worn by a consumer.

In venues such as stadiums or theatres, there is significant opportunity to promote goods and services to a large audience, either by way of advertising or availability of promotional goods within the stadium.

An example of such advertising is given in U.S. Pat. No. 6,899,391 B1, which relates to a seat back for a chair that comprises a flap extending from the upper edge of the seat back to which advertising is attached. A similar concept is described in US 2005/0080674 A1, which relates to a removable and replaceable seat back advertising panel, system, program product and method of advertising. The advertising panel displays advertisements and also allows consumer interaction by promoting contest-based or other incentives as rewards for responding to contests and advertised promotions.

However, the above-mentioned systems are necessarily confined to the stadium or similar environment, since they are an integral part of the stadium seating. The present invention is designed with the foregoing in mind.

In accordance with a first aspect of the invention a seat accessory comprising an elongate, generally planar member which is deformable in order to secure the ends to the opposite edges of a seat back, the elongate, generally planar member comprising two generally planar deformable elongate portions which are separably joined to one other, and wherein at least one of the portions, when separated, comprises a wearable item which is deformable to wrap around a body portion of a wearer.

The seat accessory provides an elongate, generally planar, deformable member which can be positioned around a seat back and onto which advertising or other promotional materials can be displayed to a consumer. The consumer can remove and disassemble the seat accessory to form one or more wearable wristbands which can be taken away from the stadium or similar venue to continue the advertising or promotion of goods or services elsewhere.

Preferably, the two generally planar deformable elongate portions, when separated, each comprise a wearable item which is deformable to wrap around the body portion of a wearer.

The two generally planar deformable elongate portions are preferably joined end-to-end.

Preferably, at least one of the generally planar deformable elongate portions comprises a deformable member.

The two generally planar deformable elongate portions may each comprise a deformable member.

One or both of the generally planar deformable elongate portions may comprise a plurality of deformable members.

The seat accessory may comprise one or more reversibly deformable members, which may be one or more bistable reversibly deformable members. The deformable members may be any suitable material capable of forming a bistable configuration, including but not limited to metal, for example, steel; or plastic. The deformable members may be coated, for example with a silicone, or fabric, or plastic coating.

At least one of the generally planar deformable elongate portions may comprise a sleeve portion within which its deformable member or members are enclosed. The deformable member or members may extend any length up to and including the length of the sleeve portion.

The sleeve portion may comprise plastic, including but not limited to polyvinyl chloride (PVC), and/or polyethylene, and/or silicone, and/or fabric.

In some embodiments, the deformable members may be surrounded by an inner sleeve, which fits inside the above-mentioned sleeve portion. The inner sleeve may comprise plastics, including but not limited to polyvinyl chloride, and/or fabric.

The two generally planar deformable elongate portions may each comprise a sleeve portion within which its deformable member or members are enclosed.

At least one of the generally planar deformable elongate portions may comprise a snap band.

The two generally planar deformable elongate portions may each comprise one or more snap bands.

The seat accessory as claimed preferably further comprises a display surface, which may be located on a face of the elongate, generally planar member, or sleeve portion.

At least one of the generally planar deformable elongate portions may comprise one or more magnetic parts.

The generally planar elongate portions may be separably joined to one another by a line of perforations, or by an elasticated member, or by one or more snap fasteners.

The generally planar elongate portions may be separably joined to one another by a retractable portion. The retractable portion may retractable within a receiving portion of one of the sleeve portions.

The display surface may comprise graphics, such as machine readable optical labels, for example bar codes, including but not limited to QR codes.

The seat accessory may comprise micro-circuitry, and, optionally, one or more flexible display screens, speakers, Light Emitting Diodes (LEDs), wireless transceivers, consumer infrared (CIR) devices, and/or proximity sensors.

The seat accessory may comprise removable portions, including but not limited to tear off advertising, coupons, promotional material, etc.

The deformable members may be in the form of bands and may be magnetic. The magnetic bands enable one or more parts of the seat accessory to be secured to a metallic surface to display advertising or other features of the display surface of the band in different environments, for example, in the home, office, etc.

At least one of the one or more sleeves may comprise a receiving portion, which may be in the form of an open-ended pocket.

The seat accessory may comprise an electronic circuit, which may optionally comprise a plurality of light emitting diodes (LEDs). The electronic circuit may further comprise a micro-processing means and machine readable medium for storing computer program code, that, when executed by the processing means, causes the LED's to illuminate in some sequence. Illumination of the LEDs may be controlled remotely, for example via a wireless connection such as Bluetooth® or infra-red radiation by means of a wireless receiver or transceiver in the electronic circuit, including but not limited to a Bluetooth® transceiver and/or a consumer infra-red receiver (CIR).

The seat accessory may further comprise an electronic visual display unit (VDU), such as an LED screen, which is preferably connected to the electronic circuit. The VDU is preferably mounted onto the display surface and may be controllable remotely, for example, via a wireless connection means in the electronic circuit.

The seat accessory may comprise a machine-readable optical label, and, optionally, a plurality of indicia. The indicia may indicate one or more of advertising, a participant consumer selectable link, or trade mark.

For the avoidance of doubt, the term “trade mark” is intended to include any indication of trade origin, such as logos, designs, words or signs.

The participant consumer selectable link(s) may comprise one or more of a trade mark, a machine-readable optical label, a hyperlink, and/or a promotional game or contest.

One or more of the participant consumer selectable link(s) preferably connects the participant to a web accessible content management system (CMS) via the wireless connection.

The one or more participant consumer selectable links may be selected by an image recognition platform.

The indicia and/or participant consumer selectable links are preferably displayed on the display surface and may be displayed by an augmented reality platform.

One or more of the LEDs or indicia may be displayed in one or more sequences, which may be pre-programmed and/or initiated and modified remotely. The one or more sequences may be programmed to synchronise with an audio stream.

The seat accessory may be attached horizontally or vertically to a seat back, relative to the seat portion, in use, and may be fitted to the front or the rear of the seat back.

The seat accessory may comprise mounting means for mounting separate promotional material thereon. For example, the seat accessory may be threaded through a portion of a separate promotional leaflet, to removably display the leaflet from the seat accessory. The leaflet, or other material, can be slidably, or otherwise removed from the seat accessory so as to be taken away from the venue by a consumer.

The seat accessory may comprise attachment means for attaching promotional material or containers to the seat accessory, for example, one or more of any of hooks, loop and pile, snap fasteners, adhesive. Any containers or similar holders are preferably suitable for retaining promotional material, including but not limited to promotional gifts, and may also be suitable for retaining a consumer's personal belongings, such as mobile telephone or tablet computer.

Specific embodiments of the invention will now be described, by way of example only, and with reference to the accompanying drawings, in which:

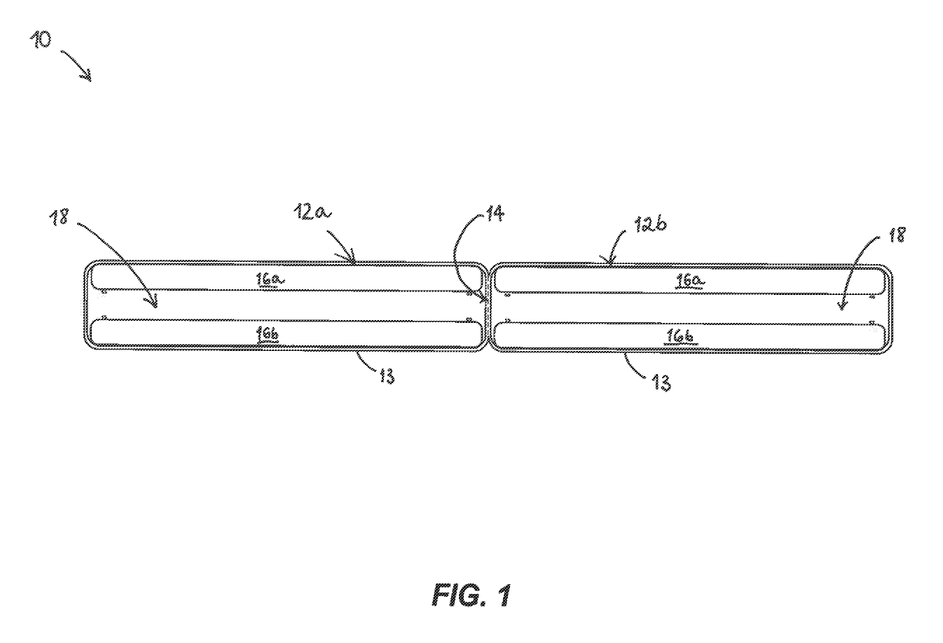

FIG. 1 is a cross sectional view of an embodiment of seat accessory in accordance with the present invention, in an extended configuration;

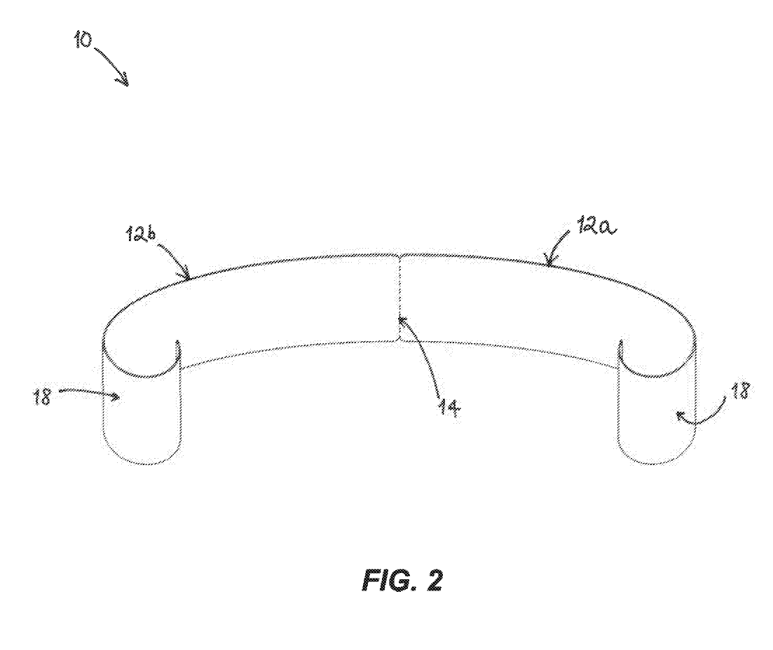

FIG. 2 is a perspective view of the seat accessory of FIG. 1 in a retracted, curved configuration;

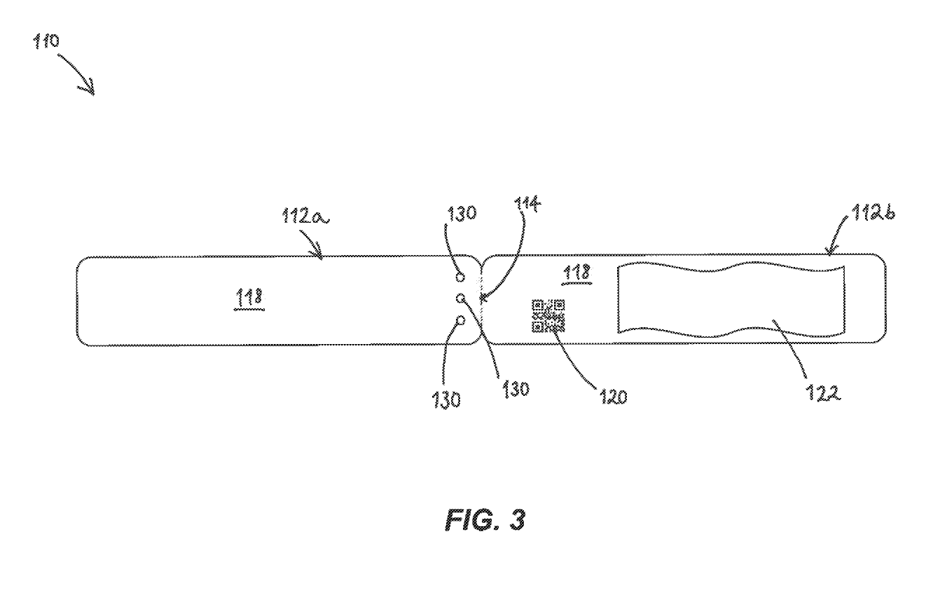

FIG. 3 is a plan view of a further embodiment of seat accessory in accordance with the present invention, with the display surface uppermost and in an extended configuration;

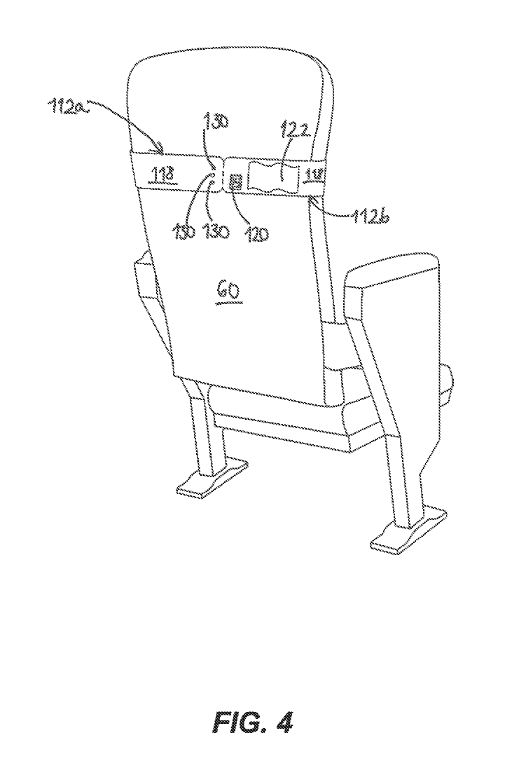

FIG. 4 is a perspective view of the seat accessory of FIG. 3 secured to a seat back in a curved configuration;

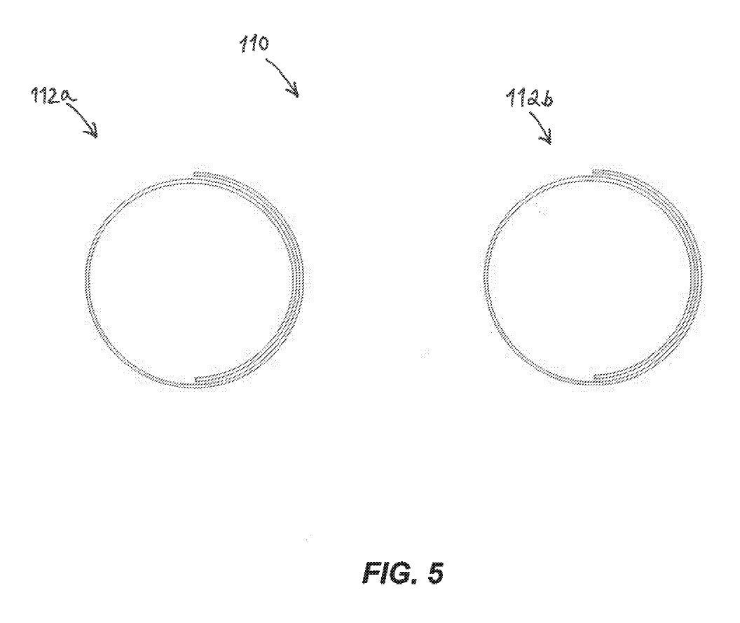

FIG. 5 is a plan view of the seat accessory of FIG. 4 separated into two wearable wristbands;

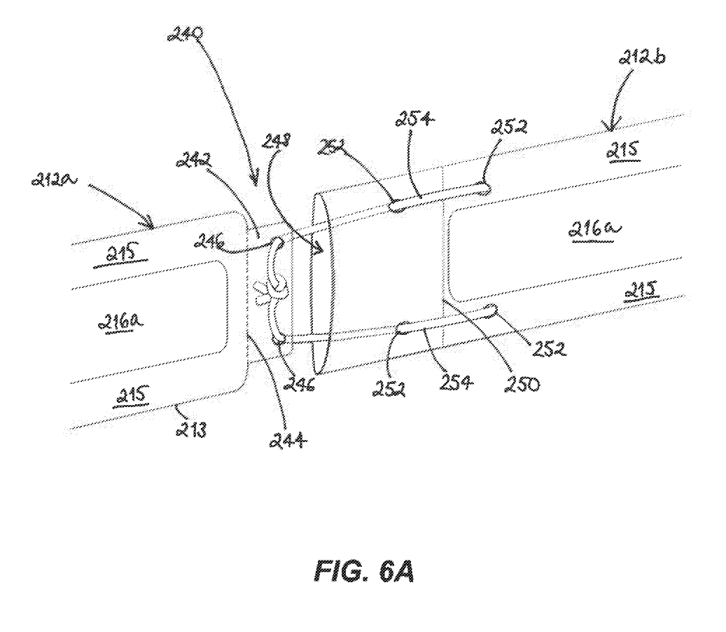

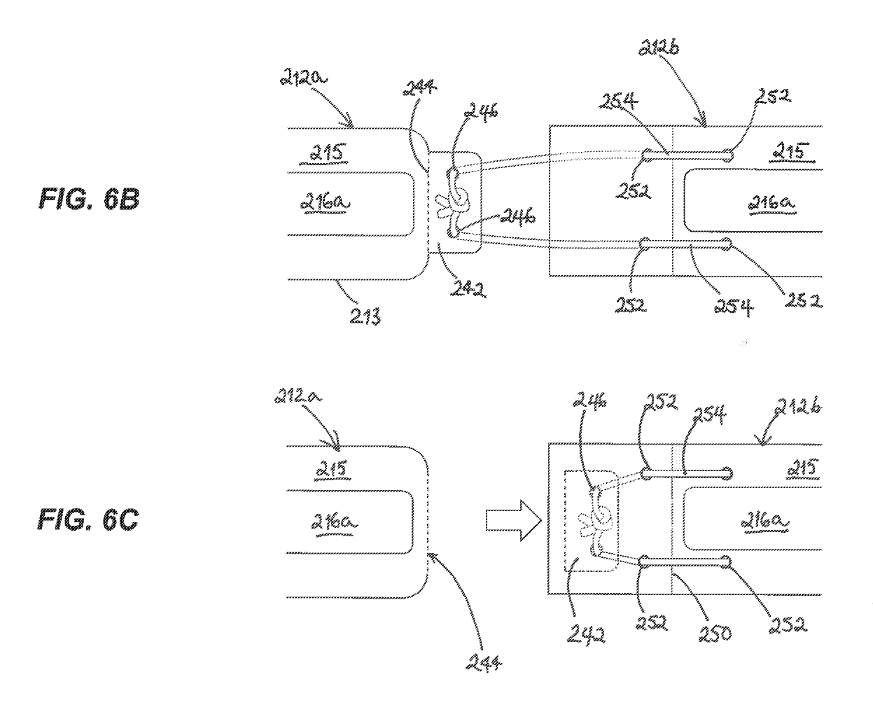

FIG. 6 is a plan view of the rear face of a still further embodiment of seat accessory in accordance with the invention, illustrating a different connection means to the perforated connection means shown in FIGS. 1 and 2, specifically, a retractable connection means.

FIG. 6A is a perspective view of the retractable connection means securing the two parts of the seat accessory together;

FIG. 6B is a plan view of the two parts being pulled away from each other during separation of the connection means; and

FIG. 6C is a plan view of the two parts separated from one another via separation of the connection means.

Referring to FIGS. 1 and 2, a seat accessory 10 comprises two identical elongate, flat substantially rectangular closed sleeves 12a, 12b of deformable plastic, arranged end-to-end and separably joined together at one end by means of a laterally extending line of perforations 14, such that the seat accessory 10 can be folded at the perforation line 14 to position one sleeve 12a overlying the other 12b. The peripheral edges of the sleeves 12a, 12b are closed by a welded seam 13.

Each sleeve 12a, 12b comprises two identical, elongate, planar, rectangular bi-stable deformable steel bands 16a, 16b, each band 16a, 16b located adjacent to a respective peripheral outer edge of each sleeve 14a, 14b, in a parallel arrangement relative to each other and to the peripheral outer edges of the sleeve 14a, 14b. Each band 16a, 16b comprises two magnets (not shown); one magnet located toward each of the peripheral edges of each band 16a, 16b. The magnets can be used for securing one or both sleeves 12a, 12b to a metallic surface, if required.

The deformable bands 16a, 16b are the same as those used in known “snap bands”, which comprise a length of layered bi-stable, flexible stainless steel. Each band 16a, 16b can be straightened out to form an elongate configuration in which the band 16a, 16b is under tension. Applying pressure to one face of the band 16a, 16b breaks this tension and causes the band 16a, 16b to retract or spring back into a substantially curved configuration.

Each sleeve 12a, 12b comprises a display surface 18, formed on one face which, in use, is positioned outermost, i.e. facing outward from a seat back. The display surface 18 is customised for an event by printing thereon images and text relevant to the event.

In use, the seat accessory 10 is arranged so that each of the bands 16a, 16b is straightened out into an extended configuration, such that the seat accessory 10 is in a substantially planar and rectangular configuration.

The seat accessory 10 is positioned against a seat back 60, with the display surface 18 facing outwards, i.e. away from the seat back 60 and with the perforation 14 substantially aligned with the centre of the seat back 60 so that the distal ends of the seat accessory 10 (i.e. the ends furthest away from the central perforation) extend beyond the sides 62a, 62b of the seat back 60.

Whilst holding the centre of the seat accessory 10 against the seat back 60, gentle pressure is applied to the distal end of each of the sleeves 12a, 12b in a direction towards the front of the seat, as indicated by arrows A. This pressure breaks the tension in the extended bands 16a, 16b and causes them to curve inward towards the front of the seat, thus wrapping the ends of each sleeve 12a, 12b around the edges of the seat back 60 to secure the seat accessory 10 to the seat. The display surface 18 faces outwardly from the seat back 60 and towards a consumer sat on the seat immediately behind the seat fitted with the seat accessory 10, so that the consumer can clearly view the content of the display surface 18.

To remove the seat accessory 10, the consumer simply grasps a portion of the sleeves 12a, 12b and pulls the seat accessory 10 away from the seat back 60. This causes the deformable bands 16a, 16b to curve inwardly at the distal end of each band 16a, 16b. The consumer can then separate the two sleeves 12a, 12b by tearing the line of perforations 14 to form two separate sleeves 12a, 12b, each sleeve 12a/12b comprising a respective deformable band 16a/16b.

Each sleeve 12a, 12b can then be worn by the consumer as a conventional “snap band” by wrapping the sleeve 12a/12b around the wrist. This can be achieved either by wrapping the sleeve 12a/12b around the wrist when it is already in a retracted, curved configuration, or by arranging the sleeve 12a/12b into an extended position, by extending the deformable band into its first, extended, planar, flat and elongate configuration and then tapping the undersurface of the sleeve 12a/12b against the wrist to cause the band to deform and retract into the second, curved configuration, as with a conventional snap band, to secure the sleeve 12a/12b around the wrist to form a wristband.

The display surface 18 is displayed outermost when worn by a consumer, thus displaying advertising, promotional material and/or consumer selectable links outermost. This is particularly useful in enabling the consumer to interact with promotional activities within the stadium, for example by presenting the wristband to a scanning device in the stadium to access promotional material or contests.

A further embodiment of seat accessory 110 is shown in FIGS. 3 to 5. The seat accessory 110 is substantially identical in configuration and operation to the above-described embodiment. However, the present embodiment additionally comprises a plurality of light emitting diodes (LEDs) 130, a battery (not visible) and a micro-circuit (not visible), embedded within one of the sleeves 112a, 112b. The same reference numerals are used to identify features of the present embodiment corresponding to features shown in FIGS. 1 and 2, increased by 100.

The display surface 118 comprises graphics, including a QR code 120, and trade marks 122, each of which can be scanned by a consumer using a mobile phone application, such as an augmented reality and image recognition (ARIR) platform, to access and interact with further promotional material and events, such as contests, as will be explained.

The ARIR platform enables a consumer to access further features, goods or services, such as dynamic content, live voting, games or other exclusive content simply by scanning various parts of display surface 118 of the seat accessory 110. A suitable ARIR platform can be downloaded by the consumer either in advance via a hyperlink or similar means, or during the event, by scanning a graphic or hyperlink on the seat accessory 110.

The seat accessory 110 comprises three circular LED's 130 positioned on the display surface of one of the sleeves 112a, adjacent the perforations 114. The LEDs 130 are electrically connected to a battery (not visible) and a micro-circuit (not visible), embedded in the same sleeve 112a. The micro-circuit comprises a Bluetooth transceiver, which connects to a remote Bluetooth transceiver within the stadium. The Bluetooth transceiver within the sleeve receives wireless signals transmitted from the stadium transceiver. The signals are transferred via the micro-circuit to a micro-processor within the circuit, which is programmed to selectively illuminate the LEDs according to a predetermined configuration, in accordance with known principles. The LEDs can therefore be programmed to selectively illuminate which can be customised, for example, to coincide with music in the stadium.

A further still embodiment of seat accessory 210 is shown in FIG. 6. The seat accessory 210 is substantially identical in configuration and operation to the above-described embodiments. However, the main difference is that the present embodiment comprises a retractable tab and cord fastener between the two sleeves, instead of the perforations of the earlier embodiments.

As a consequence, the sleeves are constructed in a slightly different manner to the previous embodiments, as will be described. The same reference numerals are used to identify features of the present embodiment corresponding to features shown in FIGS. 1 and 2, increased by 200.

Referring to FIG. 6A, as with previous embodiments, the seat accessory comprises two generally rectangular sleeves 212a, 212b, of deformable plastic, arranged end to end and joined together at the innermost ends, by a connection means 240. Each sleeve comprises a single, deformable band 216a, 216b, extending substantially the length of each of the sleeves 212a, 212b and positioned centrally between the upper and lower edges of each band, so as to leave a border 215 between the periphery of each of the bands and the corresponding periphery of the sleeves 216a, 216b. The deformable bands 216a, 216b are the same as the deformable bands of the previous embodiments.

The edges of one of the sleeves 212a are welded, with the innermost end seam adjacent the connection means 240 welded via an interrupted weld seam, i.e. a line of perforations 244. In this sleeve 212a, the deformable band 216a extends substantially the full length of the sleeve 212a.

The connection means 240 comprises a generally rectangular tab 242, joined to the end of one of the sleeves 212a by the line of perforations 214. The tab 242 is provided with two spaced apart circular apertures 246.

The innermost end of the other sleeve 212b is unwelded, so as to form an open ended generally rectangular pocket 248, which is complementarily shaped and sized with respect to the tab 242. The sleeve 212b is sealed via a weld line 250 approximately one inch (25.4 mm) from the open end of the sleeve 212b. In this sleeve 212b, the deformable band 216b extends substantially the full length of the sleeve 212b but terminates adjacent to the weld line 250, so as to leave the open ended pocket 248 empty.

The rear face of the other sleeve 212b comprises four spaced apart apertures 252 positioned towards the innermost end of the sleeve 212b so as to form a generally square configuration, with one pair of apertures 252 positioned in the respective gap 215 above and below the band 216b, and a second pair of apertures 252 positioned in the region of the open pocket 248, adjacent the seam 250.

The connection means 240 further comprises an elasticated cord 254, which is threaded inside the open pocket 248 and up through the first aperture located towards the top of the pocket 248. The cord 254 is then threaded across the rear face of the sleeve 212a and back into the sleeve 212b via the second aperture 252, positioned in the gap 215 above the band 216a. The cord 254 is threaded over the band 216a inside the sleeve 212b and out of the third aperture 252, positioned below the second aperture 252, in the gap 215 below the band 216a. The cord 254 is then threaded across the rear face of the band 212a and down into the fourth aperture 252, located below the first aperture 252 and towards the bottom of the open pocket 248, so as to leave each end of the cord 254 protruding from the open end of the pocket 248.

The cord 254 is then stretched before the uppermost end of the cord 254 is threaded through the uppermost aperture 246 of the tab 242, and the lowermost end of the cord 254 is threaded through the lowermost aperture 246 of the tab. The two ends of the cord 254 are stitched or tied together, as shown in FIGS. 6A and 6B, to form a continuous loop of elasticated cord 254 which joins the two sleeves 212a, 212b together.

When the ends of the cord 254 are released, the stretched elasticated cord 254 retracts, which draws the tab 242 into the open ended pocket 248, so as to form the seat accessory 210, which can be fitted to a seat back as per the previous embodiments.

The seat accessory 210 is removed from the seat back 260 as per the previous embodiments, by grasping a portion of the sleeves 212a, 212b to pull the curved ends of the bands away from the side edges of the seat back 260. To enable the seat accessory 210 to be worn, a consumer simply pulls each sleeve away from each other in opposing directions, which causes the elastic cord 254 to be stretched, as shown in FIG. 6B. Further stretching of the cord 254 in this manner ruptures the line of perforations 214 which removes the tab 242 from the end of the sleeve 212a to separate the sleeves 212a, 212b.

Removal of the tab 242 causes the tension on the elasticated cord 254 to be released, causing it to retract and draw the tab 254 into the open ended pocket 248, as shown in FIG. 6C. The two sleeves 212a,212b, are now separated and can be worn around a consumer's wrist, by applying pressure to one side of the sleeve 212a, 212b, causing the band 216a to deform from its extended position into a retracted, curved configuration, as explained in relation to the previous embodiments, so as to wrap around the wrist of the consumer.

An advantage with this embodiment, is that the tab 254 is securely retained within the sleeve 212b, which prevents the tab 254 from being discarded. The retractable connection means 240 therefore provides a feature which eliminates litter, i.e. discarding of the connecting tab 242, when the sleeves are separated.

The embodiments of the invention described above are described by way of example only, and other configurations may be possible, within the scope of the appended claims. For example, different connection means between the two sleeves may be possible. By way of example, such connection means may comprise a connecting tab, joined to the innermost end of each sleeve by means of a perforation at the boundary of each end of the connecting tab, and the respective innermost end of each sleeve. In a different embodiment, the connection means may comprise an elasticated panel, or a hook and loop fastener, or snap fastener (press-stud) connection means. In some embodiments, only one of the deformable members is removable from the seat accessory to form a wearable wrist band.

Insofar as embodiments of the invention described above are implementable, at least in part, using a software-controlled programmable processing device such as a general purpose processor or special-purposes processor, digital signal processor, microprocessor, or other processing device, data processing apparatus or computer system it will be appreciated that a computer program for configuring a programmable device, apparatus or system to implement the foregoing described methods, apparatus and system is envisaged as an aspect of the present invention. The computer program may be embodied as any suitable type of code, such as source code, object code, compiled code, interpreted code, executable code, static code, dynamic code, assembly code and the like. The instructions may be implemented using any suitable high-level, low-level, object-oriented, visual, data-oriented, data structured, compiled and/or interpreted programming language, such as C, C++, Java, BASIC, Perl, Matlab, Pascal, Visual BASIC, JAVA, ActiveX, assembly language, machine code, and so forth. A skilled person would readily understand that term “computer” in its most general sense encompasses programmable devices such as referred to above, and data processing apparatus and computer systems in whatever format they may arise, for example, desktop personal computer, laptop personal computer, tablet, smart phone or other computing device.

Suitably, the computer program is stored on a carrier medium in machine readable form, for example the carrier medium may comprise memory, removable or non-removable media, erasable or non-erasable media, writeable or re-writeable media, digital or analogue media, hard disk, floppy disk, Compact Disk Read Only Memory (CD-ROM), Compact Disk Recordable (CD-R), Compact Disk Rewriteable (CD-RW), optical disk, magnetic media, magneto-optical media, removable memory cards or disks, various types of Digital Versatile Disk (DVD) subscriber identity module, tape, cassette solid-state memory. The computer program may be supplied from a remote source embodied in the communications medium such as an electronic signal, radio frequency carrier wave or optical carrier waves. Such carrier media are also envisaged as aspects of the present invention.

1. A seat accessory comprising an elongate, generally planar member which is deformable in order to secure the ends to the opposite edges of a seat back, the elongate, generally planar member comprising two generally planar deformable elongate portions which are separably joined to one other, and wherein at least one of the portions, when separated, comprises a wearable item which is deformable to wrap around a body portion of a wearer.

2. A seat accessory as claimed in claim 1, wherein the two generally planar deformable elongate portions, when separated, each comprise a wearable item which is deformable to wrap around the body portion of a wearer.

3. A seat accessory as claimed in claim 1, wherein the two generally planar deformable elongate portions are joined end-to-end.

4. A seat accessory as claimed in claim 1 wherein at least one of the generally planar deformable elongate portions comprises a deformable member.

5-8. (canceled)

9. A seat accessory as claimed in claim 4, wherein at least one of the generally planar deformable elongate portions comprises a sleeve portion within which its deformable member or members are enclosed.

10. A seat accessory as claimed in claim 9, wherein the two generally planar deformable elongate portions each comprise a sleeve portion within which its deformable member or members are enclosed.

11-12. (canceled)

13. A seat accessory as claimed in claim 1, further comprising a display surface.

14. (canceled)

15. A seat accessory as claimed in claim 1, wherein the generally planar elongate portions are separably joined to one another by a line of perforations, by an elasticated member, by one or more snap fasteners, or by a retractable portion.

16-19. (canceled)

20. A seat accessory as claimed in claim 1, further comprising an electronic circuit or light emitting diodes (LEDs).

21. (canceled)

22. A seat accessory as claimed in claim 20, wherein selective illumination of the LEDs is programmable.

23. (canceled)

24. A seat accessory as claimed in claim 20, further comprising an electronic visual display unit.

25-26. (canceled)

27. A seat accessory as claimed in claim 1, wherein the seat accessory comprises a plurality of indicia.

28-29. (canceled)

30. A seat accessory as claimed in claim 27, wherein the indicia indicates one or more of a participant consumer selectable link, and wherein one or more of the participant consumer selectable link connects the participant to a web accessible content management system (CMS).

31. A seat accessory as claimed in claim 30, wherein the one or more participant consumer selectable links can be selected by an augmented reality and/or image recognition platform.

32-36. (canceled)
